(19) United States
(12) Patent Application Publication
(10) Pub. No.: US 2009/0064279 A1
(43) Pub. Date: Mar. 5, 2009

(54) System for secure remote access and control of computers

(76) Inventor: Anthony Andrew Ardolino, Crystal River, FL (US)

Correspondence Address: Anthony A. Ardolino, 605 North Lake Circle, Crystal River, FL, 34429, US

(21) Appl. No.: 11/850,604

(22) Filed: Sep. 5, 2007

(51) Int. Cl. G06F 7/04

(52) U.S. Cl. 726/3

(57) ABSTRACT

A system that anyone with a internet browser can use to set up a high security VPN between a mobile wireless hand-held devices or computer and a remote computer and operate control the remote computer. A automated internet browsers sign-up process that sets up a subscription to a VPN service and installs the required software components. A system to provide data and access control security as well as simulating a display, keyboard and mouse on a hand-held device with only a touch screen is also disclosed.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### REFERENCES

U.S. Pat. No. 6,952,731 October 2005
U.S. Pat. No. 6,671,728 December 2003
U.S. Pat. No. 6,370,576 April 2002
U.S. Pat. No. 5,949,412 September 1999
U.S. Pat. No. 5,265,239 November 1993

### TECHNICAL FIELD

The present invention relates to methods and system for anyone who can use a internet browser to have secure Remote control and access of their computers by mobile wireless hand-held devices. The new generation mobile wireless hand-held computers/devices have fully functional internet browsers and WiFi access to the internet (iPhone™ being the first such device) are robust enough to act as a remote control for and provide access to conventional computers. The users of these wireless hand-held devices may require more access to their data than email etc. that is now provide. This simple easy to use connection that was not previously available allows full access to data, programs, document etc. as if the user was sitting in front of their computer, and this can be done from anywhere in the world with a new higher level of security. The aim of the present invention is to provide a new or improved method for secure remote control and access of computer via the internet from mobile wireless hand-held device by non-technical users.

### BACKGROUND OF THE INVENTION

In resent years the internet, cell phones and the personal computer have changed the way people world wide conduct their business and personal lives. Previously wireless hand-held device such as cell phones and PDA's used low speed communication and had only limited internet access capabilities rendering them ineffective. Specifically the latest generation wireless Hand-Held devices have fully functional internet browsers supporting second generation internet application and services known as WEB 2.0 and HTML 1.1. They also have broadband wireless networking capabilities utilizing IEEE 802.3a/b and g and WiFi standards. This makes them viable computer systems with exceptional application capabilities. The first of these device is the Apple iPhone which has email and other internet application but no access to the computer, applications and data of the user. The users application such as word processing, spreadsheets database etc. generally reside on remote computers on local networks protected by a router/firewall and can not be access via the internet. The wireless hand-held device is also on a local WiFi network and can not be accessed via the internet. Both the users remote computer and hand-held device have outgoing only internet capabilities thorough routers/firewalls. As it now stand securely connecting the two without network re-configuration is not possible and has been restricted to highly technically oriented computer professionals with extensive local and wide area networking experience (LAN/WAN).

It would therefore be desirable to provide a simple method for anyone who can user a internet browser to securely connect their wireless hand-held device via the internet over a VPN (virtual private network) to their remote computer and operate and access the remote computer from the hand-held device, run application, access documents, data, download and print documents as if the user was sitting in front of the Remote Computer. And do so simply with the highest level of security without any administrative or technical intervention.

### BRIEF SUMMARY OF THE INVENTION

It is the object of the present invention to provide a method and system that is software only whereby anyone who can use a internet browser can setup a VPN to connect their mobile wireless hand-held device to the users remote computers and operate the users remote computer from the hand-held device with full control and access to the application programs and data on the remote computer as if the user were sitting in front of the remote computer.

It is a more specific object of the present invention to provide a new and unique method in which a HTTP SSL secure server can execute a cgi software program that will dynamically create a secure VPN between the hand-held device and the remote computer, while both being on local networks with routers/firewall to the internet.

It is a more specific object of the present invention to provide a new and unique method where this dynamic VPN is initiated solely by a the hand-held device making a default HTML request “GET /” to a internet relay computer and by design can be setup and destroyed in milliseconds. Both the hand-held device and remote computer by default are currently permitted to make outgoing connection request only to TCP/IP port 80 without any changes to the local networks router/firewall.

The present invention provides a new and unique method whereby only TCP/IP port 80 is used for all connection and communication. Internet relay computer that is running a HTTP SSL secure server and daemon listening for connect requests ONLY on TCP/IP Port 80 from both hand-held device and the remote computer.

It is a more specific object of the present invention provides a new and unique method for multiplexing connection and communication by utilizing IPX/SPX protocol tunneled in TCP/IP protocols on port 80 only.

It is a more specific object of the present invention to utilize the factory ethernet addresses and IMEI of the hand-held device and computer and encrypt them and embedded them in complied programs to provide additional level of security and copy protection in addition to SSL. The software is also unique in that it provides 5 levels of security; by verifying the factory ethernet addresses, IMEI number, and signed SSL certificate and will only accept request from the factory ethernet address of the hand-held device and remote computer these addresses are automatically obtained during the sign-up process, they are combined with a valid signed certificate by a recognized CA (Certificate Authority). When the connection requests are received the software program will accept connection request and connect the hand-held device and remote computer together.

It is a more specific objection of the presented invention to provide a new and unique method that someone with a internet browser may enable (sign up for) this service thus creating a secure user account, generate, download and install a customized keyed version of a software program on the users remote computer and relay computer. This software for the remote computer is also unique in that it will act as both HTTP SSL Server and a HTTP SSL client, that makes outgoing connection request to the internet relay server rather than accepting incoming connection requests. Acting as a HTTP SSL client this program will accept signed SSL certificates from the relay computer which are checked against the certificate embedded in the software during the sign-up process. This unique software program also provides copy protection will only run on one computer that matches the factory ethernet address obtained during sign-up and will cause the remote computers Display, Keyboard and Mouse to be mirrored on the hand-held device. At the same time unique software is generated and installed on the Internet relay computer that will only accept connections from the remote computer and Hand-held devices factory ethernet Address and will also verify the IMEI Number thus providing security this has no know way of being compromised.

It is another object of the invention to provide a new unique method and system in which a small HTML 1.1 software program can be download from the HTTP SSL Server on to the remote computer through the Internet relay computer HTTP SSL Secure Server to the internet browser on the hand-held device that causes that hand-held device to mirror the remote computers Display, Keyboard and Mouse and provide a unique way to run application programs on a small screen with a limited keyboard and No Mouse.

It is a more specific objection of the presented invention to provide a method using a internet browser to establish a VPN (virtual private network) between two remote computer system on local networks when both have outgoing TCP/IP Port: 80 internet access only.

Accordingly other object and a fuller understanding of the invention may be had by referring to the following Detailed Description of the preferred embodiment.

### BRIEF DESCRIPTION OF THE DRAWINGS

For a complete understanding of the presented invention and the advantages thereof, reference should be made to the following Detailed Description of the preferred embodiment taken in connection with the accompanying drawings in which.

FIG. 1 is schematic block diagram the of the Hand-Held device, relay Computer and remote computer connected to present the invention when.

FIG. 2 is a flow chart of a preferred method of the present invention for the mobile wireless hand-held device to enable the connection of FIG. 1; and

FIG. 3 is a flow chart of the present invention for the Internet relay Server HTTP SSL servers connecting the wireless hand-held device to the remote computer in FIG. 1; and

FIG. 4 is a flow chart of the present invention for the remote computer to connect to the relay server in FIG. 1; and

FIG. 5 is a flow chart of the present invention for the remote computer Fork( ) New HTTP SSL Server Process Thread( ) and process HTML request in FIG. 1; and

FIG. 6 is a flow chart of the present invention for the user of a internet browser to subscribe to the service and software generation and installation for internet relay server and remote computer.

### DETAILED DESCRIPTION OF THE PREFERRED EMBODIMENTS

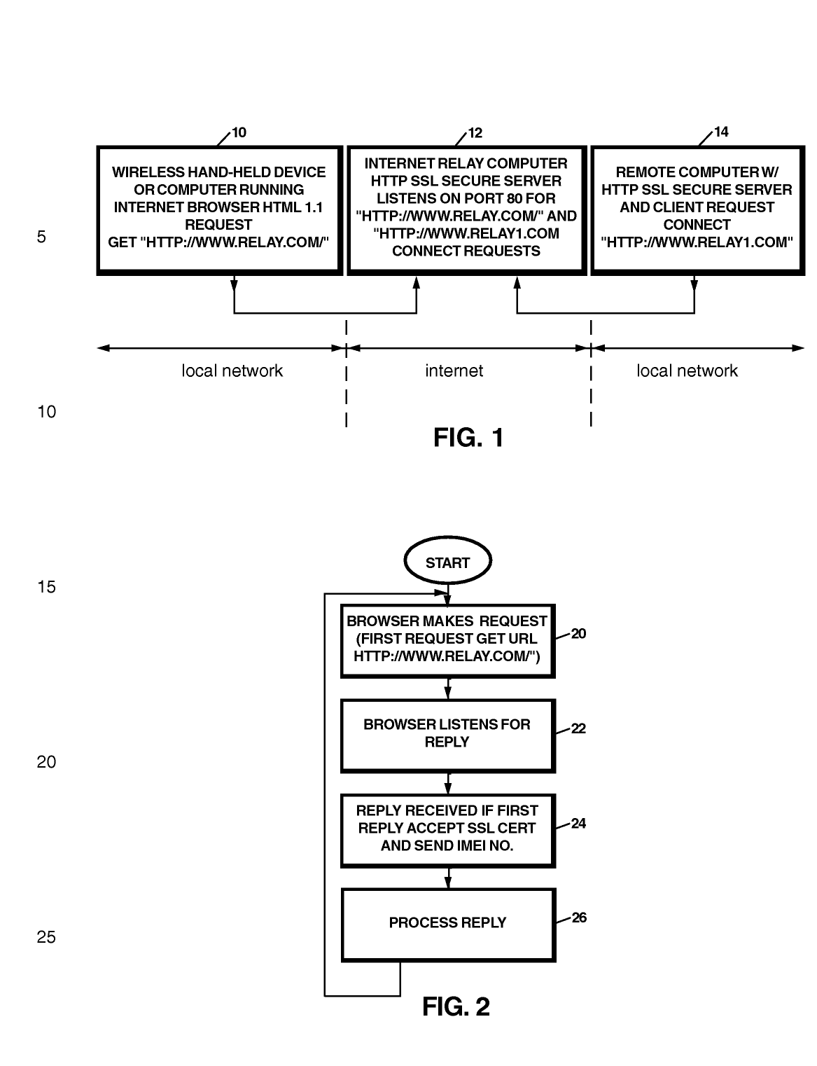

Referring now to FIG. 1, showing an overview to present the invention, schematic block diagram where a hand-held device indicated at 10 is connected to a remote computer 14 through the internet relay computer 12.

Referring now to FIG. 2, the hand-held device is running a fully functional internet browser and connected to the internet via a broadband 803.2 a/b/g or WiFi wireless network. Wireless network work have a access point connected to a local networks. The local network is connected to the internet through a router/firewall that would be running DHCP and NAT (dynamic host configuration protocol and network address translation.). All routers/firewall by default allow outgoing request to port 80, which is the default HTTP port and used by all internet browsers. To use any other port would require changes to the firewall and/or router. This is highly technical and a possible security breach. So port 80 is used exclusively in the present invention. Upon starting the browser the hand-held device the user would type in the URL “http://www.relay_domain_name.com:” indicated at 20. This URL is sent to the relay computer then to the remote computer, the remote computer reply is received at 22 the SSL certificate is download from the www.relay.com. is first downloaded, next the hand-held device javascript software is downloaded from the remote computer. The hand-held device sends IMEI international mobile equipment identity 24 and a secure connection is established and process loop begin 26 to 20. The remote computers display screen is now download and displayed on the hand-held device. Touch screen inputs and touch screen keyboard inputs are converted to conventional mouse and keyboard inputs by the javascript software in the hand-held device. Then sent to remote computer and the display screen is refreshed accordingly. The javascript software listing is in appendix a CDROM file name “index.html”.

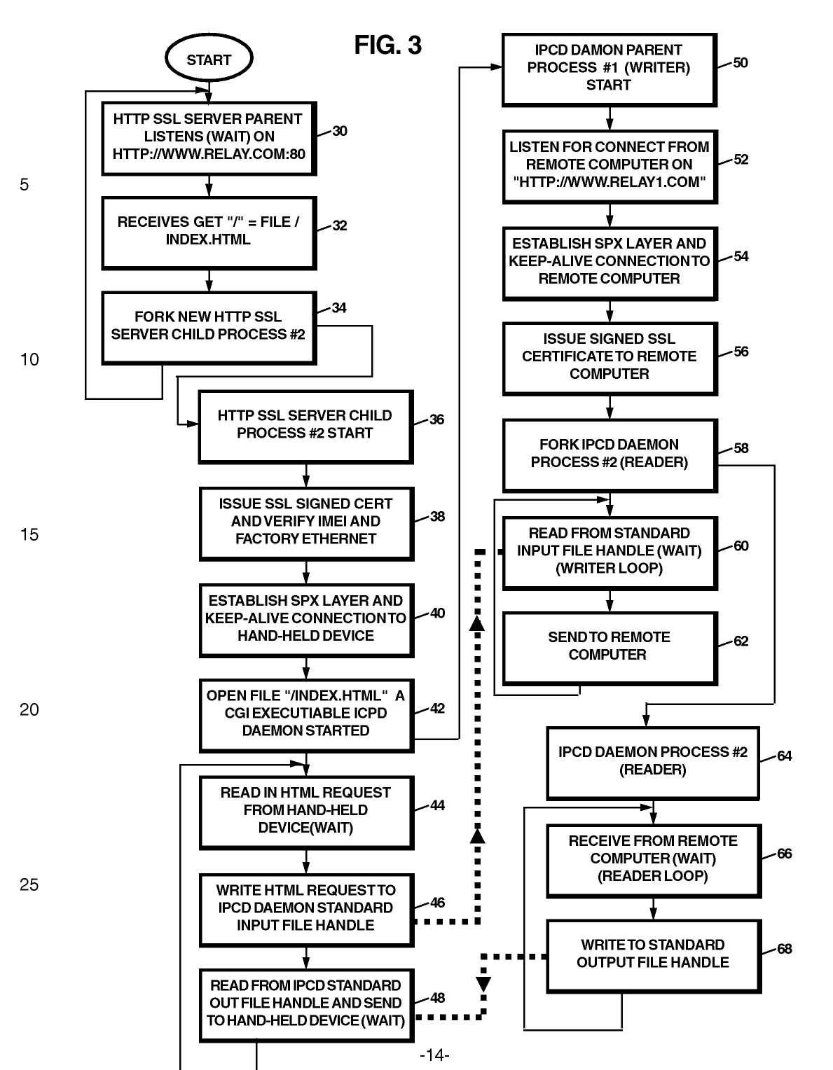

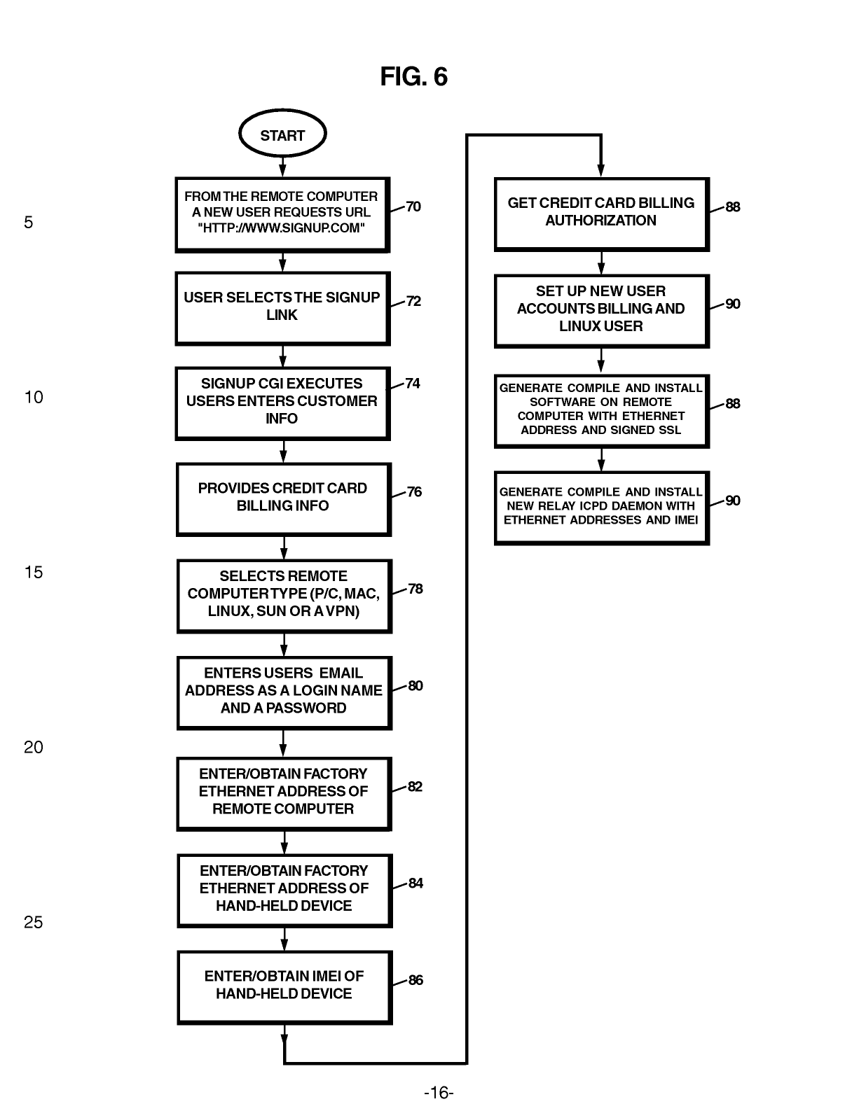

Referring now to FIG. 3, a Intel based computer connected to the internet running CentOS 4 enterprise version of the Linux operating system. Upon system start the Apache httpd-2.0 server daemons are started. The Apache servers SSL configuration file “/etc/httpd/conf.d/ssl.conf” has a virtual host configured <VirtualHost www.relay.com:80> with SSLCertificateFile, SSLCACertificatePath, SSLCertificateKeyFile also configured along with paths to cgi and html directories. The HTTP SSL virtual host “www.relay.com” at 30 listen on port 80 for a “GET /” request from the hand-held device 32. The “GET /” indicates file “index.html” in the html directory path. The parent HTTP process forks a new child process 34 to handle the request. 36 the child http process then issues the ssl certificates, verifies the factory ethernet address and IMEI number of the hand held device 38. A SPX type connection is established using the default network number “0” and the hand held device ethernet address. 40 the html replies from this point on will have “connection=keep-alive” set to maintain the connection and increase performance. 42 the file html directory path “index.html” is open and a “href” is made to the ipcd daemon process is started 42. 44 the http child process loops reading html request from the hand-held device and writing those request to the standard input file of the ipcd daemon process 46. The loop then reads (waits if nothing to read) from the ipcd daemon standard output file handle. 48 when data is read it is sent to the hand-held device and the child http process continues and loops to 44. At 50 the ipcd daemon process starts to listen for a connect request on “http://www.relay1.com:80” 52, and waits, 54 upon receiving a connect request from the remote computer which is polling every 3 seconds trying to connect to “http://www.relay1.com:80” the polling fails until the ipcd daemon establishes the listen 52. A SPX protocol layer is establish with the remote computer and connection=keep-alive is set. The SSL certificate is sent to the remote computer 56 and the ipcd daemon parent process forks a child process 58 (reader) and the parent process continues to loop (writer) reading from it's standard input file handle (wait) 60 html request from the hand-held device 46 and upon reading data it is sent to the remote computer 62 the parent process continues the loop back to 60. 64 the ipcd daemon child process (reader) receives data from the remote computer 66 (wait) and upon receiving data it is written the standard output file handle 68 which is read 48 and sent to the hand-held device. The parent process (writer) 60 and 62 continue to loop reading html from the hand-held device and sending those request to the remote computer. At the same time the child process (reader) continues to receive the html replies from the remote computer and send them to the hand-held device 66 and 68. The ipcd daemon software was compiled and installed during the sign-up FIG. 6 and contains the hard coded ethernet addresses of both the hand-held device and the remote computer, the SSL certificate and IMEI number. The daemon will only run if all match providing the highest possible level of security.

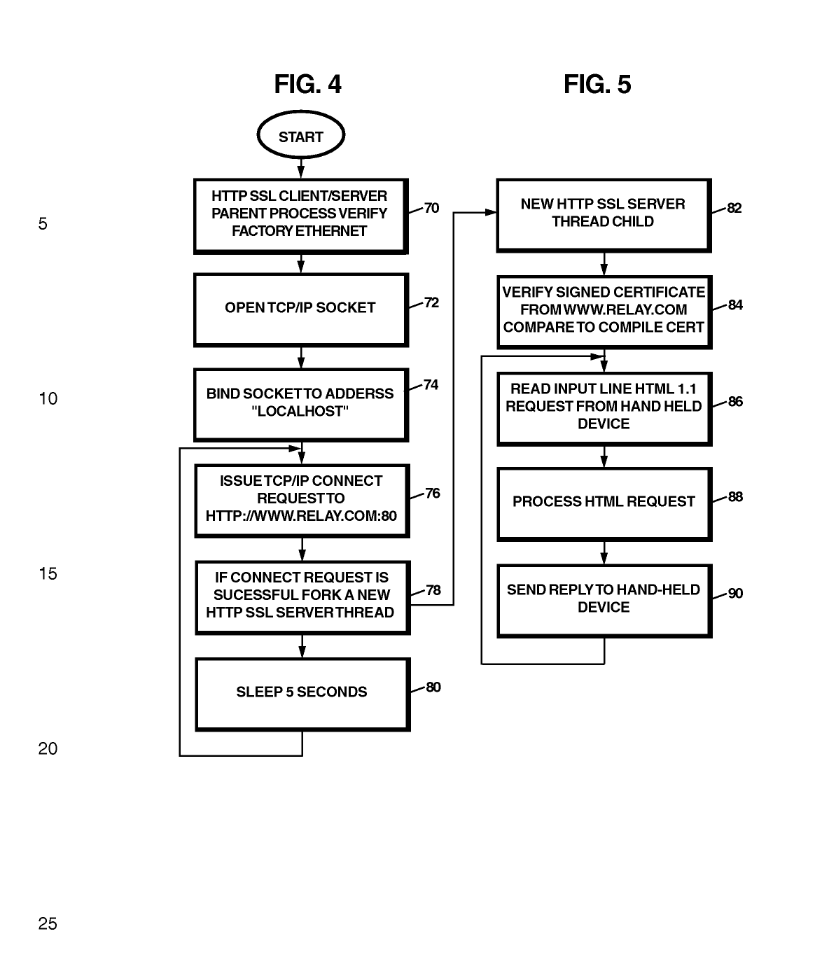

Referring now to FIG. 4 and FIG. 5 during the sign-up process FIG. 6 software was generated and installed on the remote computer with hard coded SSL certificates and ethernet addresses of both the hand-held device and remote computer This software is a registered service and start when the computer starts providing the ethernet addresses matches 70. The program start as a html client (like a browser) 72 a TCP/IP socket is opened and bound to the address “localhost” 74. 76 a loop starts sending connects to “http://www.relay1.com:80” which fail the ipcd daemon is started on the relay computer by the hand-held device making a “GET /” request. 80 if the connect fail the process sleeps 3 seconds loop to 76 and retries the connect. 78 if the connect succeeds a new child thread is started 82 and the parent process continues to make connection requests to the relay computer. 84 the child thread verified the SSL certificate sent form the relay computer matching it to the one hard coded in the software. 86 starts a loop reading lines of html request from the hand-held device. 88 processing those html request and sending the html replies 90 back to the hand-held device. This process continues reading simulated keyboard and simulated mouse events from the hand-held device and sending display refreshes based on those inputs back to the hand-held device. All the programs for the hand-held device, relay server and remote are designed to be very lightweight in terms of program size, speed and processor load and many connection from the hand-held device to the relay server and remote computer can occur in just a few milliseconds without imposing any measurable load on any computer involved. This ability to make and break connection quickly and easily is a dynamic fail safe error recovery feature, if something goes wrong the hand-held device will time out and retry the request and the whole process starts anew.

Referring now to FIG. 6 the sign-up HTTP SSL secure server another virtual host on the relay computer <VirtualHost www.signup.com:80> a customer wishing to have access to his computer from his hand held device would use a internet browser to go to URL “http://www.signup.com” 70 and select the sign-up link 72. 74 the sign-up cgi program executes and the customer enter billing information name, address, phone etc. 76 credit card information is entered. 78 the type of remote computer is selected Windows P/C, Apple Mackintosh, Linux or Sun or a VPN. 80 the user name (valid email address) and password are entered. 82 the ethernet addresses and 86 IMEI of the hand-held device and remote computer 84 are read in automatically. This is assuming the hand-held device is connected to the a Window or Mac remote computer (iPhone with iTunes) if not the customer enter the values manually and is instructed where to find them. 88 after the all the data is entered and verified the customers credit is charged the first month subscription fee. 90 a new customer account is establish in the billing system sql database and a new Linux user account and password are setup for account maintenance etc. 88 the source code for the remote computer is edited (sed) and the ethernet address, IMEI and SSL certificate are inserted. The program is compiled downloaded to remote computer and installed. 90 the ipcd daemon source code is edited (sed) and the ethernet address, IMEI and SSL certificate are inserted the program is compile and installed in the cgi directory of the HTTP SSL secure server “www.relay.com”.

Referring to appendix. A computer program listing will further detail the function described to those skilled in the art.

1. A method for anyone that can use a internet browser to have secure access and control of a computer from a hand-held device or another computer.

2. A method where a default html request “GET /” from a internet browser will create or destroy a dynamic VPN in milliseconds between the device or computer making the request and a remote computer.

3. A method for simulating a computer display keyboard and mouse on a hand-held device with only a touch screen with a simple downloaded html script.

4. A method to automate the setup of a subscription to a service to provide secure VPN (virtual private network) service using a internet browser.

5. A method for anyone that can use a internet browser to set up a high security VPN over the internet between two computers on local networks.

6. A method to automatically obtain the ethernet addresses and IMEI number from a computer using a browser and a hand-held device that is connected to that computer.

7. A method to use TCP/IP port 80 exclusively for a internet VPN where IPX/SPX protocol
is tunneled over TCP/IP and multiplexes/routes the traffic on port 80 to the correct process.

8. A method to use the paired hardware ethernet addresses of two computer on a VPN as cipher to encrypt and decrypt already encrypted SSL data to provide higher level of security than provided by SSL, with no known way to compromise.

9. A method to use the hardware ethernet address as a cipher for software copy protection.

10. A method to provide five levels of security, ethernet address verification, encrypt/decrypt based ethernet address ciphers, proprietary IPX/SPX protocols, IMEI verification and SSL.

11. A method for a software program to act as both a HTTP SSL client and server.
